(19) United States
(12) Patent Application Publication
(10) Pub. No.: US 2022/0074231 A1
(43) Pub. Date: Mar. 10, 2022

(54) LOCKSET AND CASE

(71) Applicant: SINOX LOCK (KUNSHAN) CO., LTD., Kunshan (CN)

(72) Inventor: Xiaodi ZHANG, Kunshan (CN)

(21) Appl. No.: 17/462,135

(22) Filed: Aug. 31, 2021

(30) Foreign Application Priority Data
Sep. 4, 2020 (CN) 202010920616.6

(51) Int. Cl. E05B 37/00; E05B 65/52

(52) U.S. Cl. CPC E05B 37/0031; E05B 9/02; E05B 65/5215

(57) ABSTRACT

Provided are a lockset and a case. The lockset includes a housing, a lock bolt and a key lock mechanism. The key lock mechanism includes a lock lever, an unlocking button and a lock core. The lock lever can rotate along with the lock core and can drive the lock core to slide. The unlocking button is hooked to the lock bolt and can slide along with the lock lever. When the lock core is locked, the lock lever abuts against the lock bolt to keep the lock bolt in a locked position and when the lock core is unlocked, the lock core drives the lock lever to rotate by a preset angle in an unlocking direction and drives the unlocking button to slide to make the unlocking button hooked to the lock bolt and thereby make the lock bolt move to an unlocked position.

### CROSS-REFERENCE TO RELATED APPLICATION(S)

This application claims priority to Chinese Patent Application No. 202010920616.6 filed Sep. 4, 2020, the disclosure of which is incorporated herein by reference in its entirety.

### TECHNICAL FIELD

The present disclosure relates to the technical field of locksets and, in particular, to a lockset and a case.

### BACKGROUND

To ensure the safety of luggage, people often use a case with a lockset to load items when going out. The case includes, but is not limited to, a suitcase and a briefcase.

The lockset of the suitcase is generally used with the zipper of the case. When the zipper is fastened, the zipper puller of the zipper is inserted or embedded into the keyhole of the preceding lockset, and then a component such as a lock bolt that can move in the keyhole of the lockset is threaded into the hole in the zipper slider. In this manner, the zipper is locked.

The preceding lockset usually includes a transportation security administration (TSA) key lock (commonly known as a customs lock). When a user or a customs inspector uses a key to unlock a key lock, the user or the customs inspector needs to rotate and unlock the lock core of the key lock through the key and then push an unlocking button linked with the lock bolt to unlock the key lock. That is, a key lock based on an existing lockset structure is unlocked in at least two steps: unlocking and pushing the unlocking button, that is, not easy to unlock.

### SUMMARY

An object of the present disclosure is to provide a lockset and a case. The key unlocking process of the lockset is convenient and avoids the complex operation in which an unlocking button linked with a lock bolt needs to be pushed to unlock a key lock after a lock core of the key lock is rotated and unlocked.

To achieve the object, the present disclosure adopts the solutions below.

A lockset includes a housing, a lock bolt disposed inside the housing and a key lock mechanism disposed inside the housing. The key lock mechanism comprises a lock lever, an unlocking button and a lock core. The lock lever which is slidably connected to the housing can rotate along with the lock core and drive the lock core to slide. The unlocking button is hooked to the lock bolt and can slide along with the lock lever. When the lock core is locked, the lock lever configured to abut against the lock bolt to keep the lock bolt in the locked position. When the lock core is unlocked, the lock core is configured to drive the lock lever to rotate by the preset angle in the unlocking direction and drive the unlocking button to slide so as to make the unlocking button hooked to the lock bolt and thereby make the lock bolt move to an unlocked position.

In an embodiment, a protrusion is disposed inside the housing. After the lock core drives the lock lever to rotate by the preset angle in the locking direction, the lock lever can abut against the protrusion to form a sway pivot point to make the lock lever sway around the sway pivot point when the lock core continues rotating in the unlocking direction.

In an embodiment, the lock bolt is configured to use a resilient element to connect to or abut against the housing. When the lock bolt is in the unlocked position, the resilient element is configured to generate resilient deformation and form resilient potential energy for resetting the lock bolt to the locked position.

In an embodiment, the unlocking button is slidably connected to the housing and the lock core may be rotatably connected to the unlocking button in a manner of rotating around an axis of the lock core.

In an embodiment, the unlocking button is configured to slide only along the direction of the line connecting the unlocked position and the locked position to limit the sliding direction of the lock lever.

In an embodiment, a first plug portion is formed on one side facing toward the lock lever of the lock core, and a second plug portion is formed on one side facing toward the lock core of the lock lever. The first plug portion can be plugged into the second plug portion and can slide along the second plug portion.

In an embodiment, the second plug portion is configured to extend in a direction parallel with a direction of a line connecting the unlocked position and the locked position when the lock core is locked.

In an embodiment, the lockset further includes a combination lock mechanism. The lock bolt, the key lock mechanism and the combination lock mechanism are disposed in sequence.

When the combination lock mechanism and the lock core are locked, the combination lock mechanism is configured to abut against the lock lever.

When the combination lock mechanism is unlocked, the combination lock mechanism is configured to stop abutting the lock lever to enable the key lock mechanism to move towards the combination lock mechanism so as to make the unlocking button hooked to the lock bolt and thereby make the lock bolt move to the unlocked position.

The present disclosure further adopts the solutions below.

A case includes a case body and the lockset as described in the preceding. A zipper is disposed on the case body and a zipper puller of the zipper can engage with the lock bolt of the lockset to lock the zipper.

In an embodiment, the lockset further includes an ejection mechanism that is configured to eject the zipper puller out of the lockset when the lock bolt is in the unlocked position.

Moreover, the present disclosure has the beneficial effects below.

In the lockset according to the present disclosure, when the key lock mechanism is unlocked, the lock core is rotated through the key and, while torque is being continuously applied to the lock core, the coherent action of rotation and sway of the lock lever can be implemented to make the lock lever drive the unlocking button to unlock the key lock. That is, the unlocking action is completed in one step, and the complex operation of pushing the unlocking button linked with the lock bolt to unlock the key lock after the lock core of the key lock is unlocked is unnecessary, so the unlocking process is more coherent and more convenient.

### BRIEF DESCRIPTION OF DRAWINGS

FIG. 1 is a schematic view illustrating the structure of a lockset according to embodiments of the present disclosure.

FIG. 2 is a schematic view illustrating the structure of a lockset whose upper cover is not disposed according to embodiments of the present disclosure.

FIG. 3 is a schematic view taken from another perspective to illustrate the structure of a lockset whose upper cover is not disposed according to embodiments of the present disclosure.

FIG. 4 is a schematic view illustrating the structure of a key lock mechanism according to embodiments of the present disclosure.

FIG. 5 is a schematic view illustrating the structure of a key lock mechanism that is locked according to embodiments of the present disclosure.

FIG. 6 is a schematic view illustrating the structure of a key lock mechanism in an unlocking process according to embodiments of the present disclosure.

FIG. 7 is a schematic view illustrating the structure of a key lock mechanism that is unlocked according to embodiments of the present disclosure.

### REFERENCE LIST

1 housing
11 upper cover
111 sliding groove
12 soleplate
13 keyhole
14 protrusion
2 lock bolt
21 abutting portion
3 key lock mechanism
31 lock lever
311 second plug portion
32 unlocking button
33 lock core
331 first plug portion
4 combination lock mechanism
41 cam
42 mandrel
5 ejection mechanism
P sway pivot point

### DETAILED DESCRIPTION

The present disclosure is further described below in detail in conjunction with drawings and embodiments. It is to be understood that the embodiments described herein are merely intended to explain the present disclosure and not to limit the present disclosure. Additionally, it is to be noted that for ease of description, merely part, not all, of the structures related to the present disclosure are illustrated in the drawings.

In the description of the present disclosure, unless otherwise expressly specified and limited, the term “connected to each other”, “connected”, or “fixed” is to be construed in a broad sense, for example, as permanently connected, detachably connected, or integrated; mechanically connected or electrically connected; directly connected to each other or indirectly connected to each other via an intermediary; or internally connected or interactional between two components. For those of ordinary skill in the art, specific meanings of the preceding terms in the present disclosure may be construed based on specific situations.

In the present disclosure, unless otherwise expressly specified and limited, when a first feature is described as “above” or “below” a second feature, the first feature and the second feature may be in direct contact or be in contact via another feature between the two features. Moreover, when the first feature is described as “on”, “above”, or “over” the second feature, the first feature is right on, above, or over the second feature or the first feature is obliquely on, above, or over the second feature, or the first feature is simply at a higher level than the second feature. When the first feature is described as “under”, “below” or “underneath” the second feature, the first feature is right under, below or underneath the second feature or the first feature is obliquely under, below or underneath the second feature, or the first feature is simply at a lower level than the second feature.

In the description of the embodiment, the orientation or position relationships indicated by terms “above”, “below”, “right” and the like are based on the orientation or position relationships shown in the drawings, merely for facilitating description of the present disclosure and simplifying operation, and these relationships do not indicate or imply that the referred device or element has a specific orientation and is constructed and operated in a specific orientation, and thus it is not to be construed as limiting the present disclosure. In addition, the terms “first” and “second” are used only to distinguish between descriptions and have no special meaning.

The present embodiment provides a lockset that is used for a suitcase. However, in other embodiments, the lockset may also be used for a suitcase or a briefcase and the like. The key unlocking process of the lockset is convenient and avoids the complex operation in which an unlocking button hooked to a lock bolt needs to be pushed to unlock a key lock after a lock core of the key lock is rotated and unlocked.

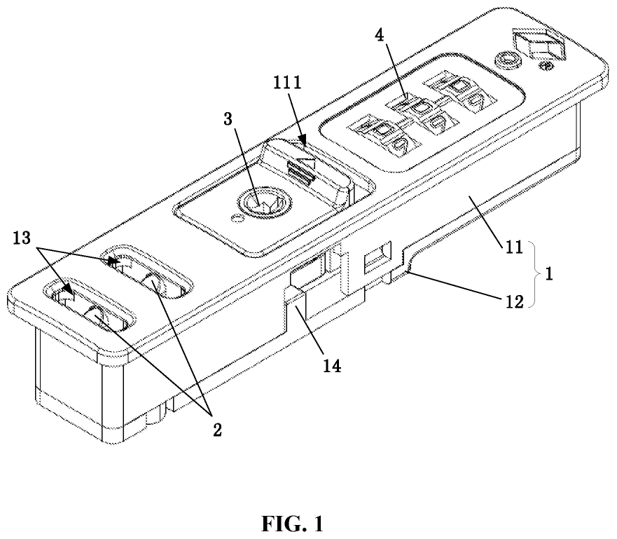

In conjunction with FIGS. 1 to 7, the lockset is described below using an example in which the lockset is applied to a suitcase.

The suitcase includes a case body and a lockset. A zipper is disposed on the case body. The lockset and a locking tab passing through a locked zipper puller achieve the purpose of locking the zipper.

Referring to FIGS. 1 to 3, the lockset includes a housing 1, a lock bolt 2 disposed inside the housing 1 and a key lock mechanism 3 disposed inside the housing 1. As shown in FIG. 1, the housing 1 includes an upper cover 11 and a soleplate 12. The upper cover 11 and the soleplate 12 can be fastened with each other to form a cavity. A keyhole 13 for the zipper puller to be penetrated into the cavity is provided on the upper cover 11. The lock bolt 2 and the key lock mechanism 3 are both disposed inside the cavity and the lock bolt 2 is provided with an unlocked position and a locked position. When the lock bolt 2 is in the unlocked position, the lock bolt 2 staggeredly bypasses the keyhole 13 to allow the zipper puller to be penetrated through the cavity. When the lock bolt 2 is in the locked position, the lock bolt 2 extends into a perforation at the head of the zipper puller to lock the zipper puller so as to ensure the case body in a closed state.

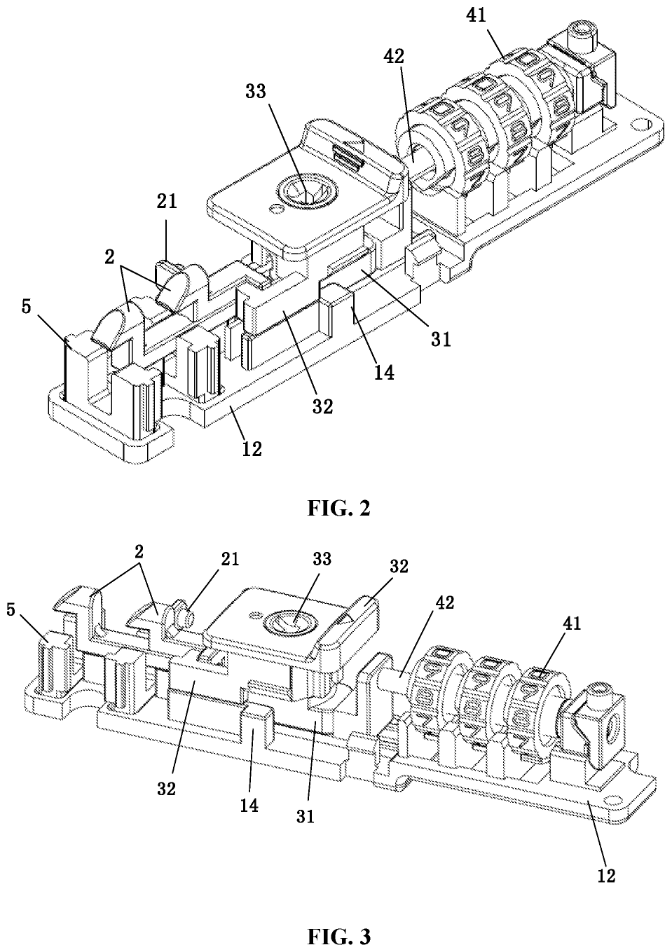

Referring to FIGS. 2 to 3, the key lock mechanism 3 includes a lock lever 31, an unlocking button 32 and a lock core 33. The lock lever 31 can rotate along with the lock core 33, is slidably connected to the housing 1 and can drive the lock core 33 to slide. The unlocking button 32 is hooked to the lock bolt 2 and can slide along with the lock lever 31.

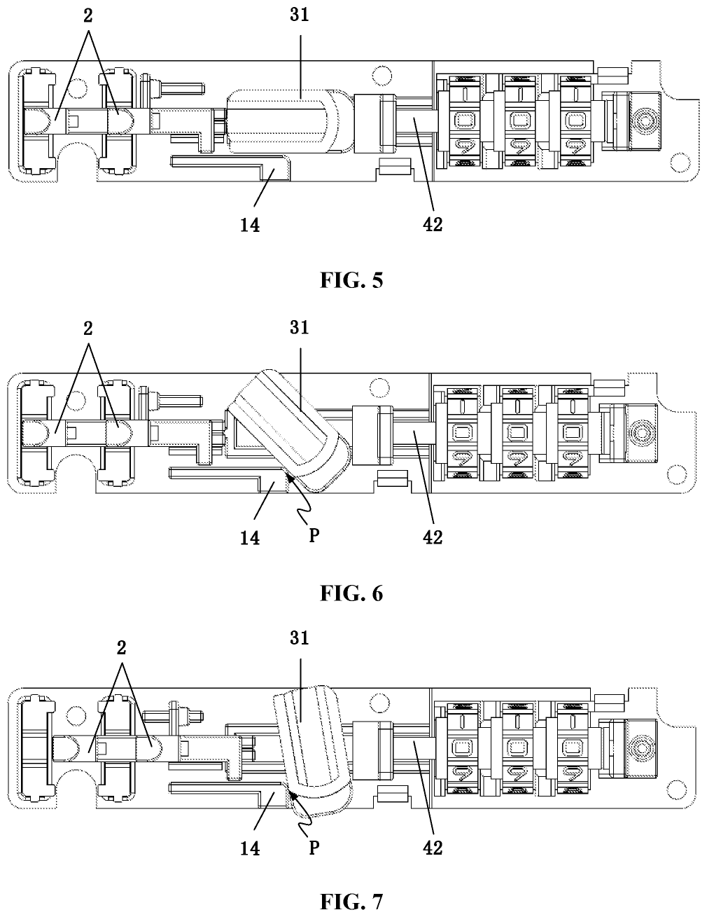

Referring to FIGS. 5 to 7, first, as shown in FIG. 5, when the lock core 33 is locked, the lock lever 31 abuts against the lock bolt 2 to keep the lock bolt 2 in the locked position. When the lockset is unlocked through a key, the key is inserted into the keyhole 13 of the lock core 33 and the lock lever 31 can rotate along with the lock core 33 through rotating the key. Simply in this manner, the lock core 33 can drive the lock lever 31 to rotate by a preset angle in the unlocking direction around an axis of the lock core 33 and drive the lock core 33 and the unlocking button 32 to slide to make the unlocking button 32 hooked to the lock bolt 2 and thereby make the lock bolt 2 move to the unlocked position so as to accomplish the unlocking action.

In summary, in the preceding unlocking action, the lock core 33 is rotated through the key and, during the process of torque being continuously applied to the lock core 33, the coherent action of rotation and sway of the lock lever 31 is implemented to enable the lock lever 31 to drive the unlocking button 32 to unlock the key lock. That is, the unlocking action is completed in one step and the complex operation in which the unlocking button linked with the lock bolt 2 is pushed to unlock the key lock after the lock core 33 of the key lock is unlocked is unnecessary, so the unlocking process is more coherent and more convenient.

In the present embodiment, a protrusion 14 may be disposed inside the housing 1. When the lock core 33 drives the lock lever 31 to rotate by the preset angle in the unlocking direction, the lock lever 31 can abut against the protrusion 14 to form a sway pivot point P. At this time, the position of the lock bolt 2 is not changed and the position of the lock lever 31 is shown as FIG. 6. With continued reference to FIG. 7, when the key is continuously rotated to apply the torque rotating toward the unlocking direction to the lock core 33, since the lock lever 31 is slidably connected to the housing 1, the lock lever 31 can sway around the sway pivot point P. Such sway actions can drive the lock core 33 and the unlocking button 32 to slide to make the unlocking button 32 hooked to the lock bolt 2 and thereby make the lock bolt 2 move to the unlocked position so as to accomplish the purpose of the unlocking action.

It is to be noted that the position, preset angle and sway angle of the preceding protrusion 14 may be adaptively adjusted based on the inherent parameters of the lockset such as the unlocking rotation angle of the lock core 33, the unlocking actuation displacement of the lock bolt 2 and the interference structure position of the cavity of the lock body, so these parameters are not limited herein.

In the present embodiment, to make the lock bolt 2 automatically reset to the locked position after the lock bolt 2 is unlocked, the lock bolt 2 may use a resilient element to connect to or abut against the housing 1. When the lock bolt 2 is in the unlocked position, the resilient element generates resilient deformation and forms resilient potential energy for resetting the lock bolt 2 to the locked position.

Referring to FIG. 3, an abutting portion 21 is disposed on the lock bolt 2 and a baffle is protruded inside the cavity in the upper cover 11. A compression spring is connected or abutted between the baffle and the abutting portion 21. The extending direction of the compression spring is parallel to the unlocking actuation direction of the lock bolt 2 so that when the lock bolt 2 moves from the locked position to the unlocked position, the abutting portion 21 is compressed against the compression spring to make the compression spring shrink and accumulate energy. When the external force unlocking the lock bolt 2 is withdrawn, the compression spring stretches and the lock bolt 2 is reversely hooked to the unlocking button 32. Simply in this manner, the lock bolt 2 can be reset to the locked position and, moreover, the whole key lock mechanism 3 is reset simultaneously.

It is to be understood that one side facing away from the lock bolt 2 of the key lock mechanism 3 is provided with a solid element provided by the housing 1 or other locking mechanisms that can provide abutting structures for the key lock mechanism 3 so that when the lock core 33 is locked, one end of the lock lever 31 abuts against the lock bolt 2 while the other end of the lock lever 31 is compressed against the solid element having a stable space position so as to keep the lock bolt 2 in the locked position.

In an embodiment, the lockset may further include a combination lock mechanism 4. The lock bolt 2, the key lock mechanism 3 and the combination lock mechanism are disposed in sequence. The combination lock mechanism 4 may serve as the solid structure for providing abutment for the key lock mechanism 3.

With continued reference to FIGS. 2 and 3, the combination lock mechanism 4 includes a plurality of cams 41 and a mandrel 42 disposed to pass between the plurality of cams 41. When the plurality of cams 41 are rotated to the correct positions, the engagement between the plurality of cams 41 and the mandrel 42 can be released and the mandrel 42 is allowed to move away from the key lock mechanism 3. Since the combination lock mechanism 4 is an existing art, the specific structure of the combination lock mechanism 4 for implementing the preceding action object is not described herein.

In view of the above, when the combination lock mechanism 4 and the lock core 33 are locked, the mandrel 42 of the combination lock mechanism 4 abuts against the lock lever 31 and then the lock lever 31 abuts against the lock bolt 2 to keep the lock bolt 2 in the locked position. When the combination lock mechanism 4 is unlocked, the combination lock mechanism 4 stops abutting the lock lever 31 to enable the key lock mechanism 3 to move towards the combination lock mechanism 4 under a human push so as to make the unlocking button 32 hooked to the lock bolt 2 and thereby make the lock bolt 2 move to the unlocked position.

In the present embodiment, the unlocking button 32 is slidably connected to the housing 1 and the lock core 33 may be rotatably connected to the unlocking button 32 in a manner of rotating around the axis of the lock core 33. The unlocking button 32 is preferably configured to slide only along the direction of the line connecting the unlocked position and the locked position to define the sliding direction of the lock lever 31 as the direction of the line connecting the unlocked position and the locked position. It is to be understood that the unlocking button 32 is at least provided with a push button-shaped handling element disposed on the outer surface of the housing 1 and an unlocking element positioned inside the housing 1 and hooked to the lock bolt 2 to facilitate the unlocking operation through the combination lock mechanism 4 alone. The handling element and the unlocking element of the unlocking button 32 may be formed into an unitary structure, for example, through injection molding, so that intermediate transmission between the handling element and the unlocking element is unnecessary, making the handling member and the unlocking member suitable for the unlocking action of the combination lock mechanism 4. Moreover, the keyhole 13 end of the lock core 33 passes through the unlocking button 32 to facilitate unlocking the key lock through the key.

As shown in FIGS. 1 and 2, the upper cover 11 is provided with a sliding groove 111 and the extending direction of the sliding groove 111 is parallel to the direction of the line connecting the unlocked position and the locked position. The unlocking button 32 is provided with a guiding portion slidably connected inside the sliding groove 111 and the guiding portion is substantially rectangular so that the guiding portion can slide only along the extending direction of the sliding groove 111. Moreover, since the lock core 33 moves along with the unlocking button 32, once the lock core 33 has a certain sliding direction, the lock lever 31 linked with the lock core 33 has a certain sliding direction.

In the unlocking process, the lock lever 31 needs to complete the rotation action coaxial with the lock core 33 and the sway action in which the axis of the lock core 22 is not taken as the pivot point. That is, the lock lever 31 needs to displace relative to the lock core 33. To this end, in the present embodiment, a first plug portion 331 is formed on one side facing toward the lock lever 31 of the lock core 33 and a second plug portion 311 is formed on one side facing toward the lock core 33 of the lock lever 31. The first plug portion 331 can be plugged into the second plug portion 311 and slide along the second plug portion 311 so that when the lock lever 31 rotates coaxially with the lock core 33, the first plug portion 331 drives the second plug portion 311 to rotate. That is, when the lock core 33 drives the lock lever 31 to rotate and the lock lever 31 sways around the sway pivot point P and displaces relative to the lock core 33, the first plug portion 331 slides along the second plug portion 311 to eliminate the relative displacement deviation between the lock lever 31 and the lock core 33 and to ensure that the two are kept in the connected state of synchronous rotation.

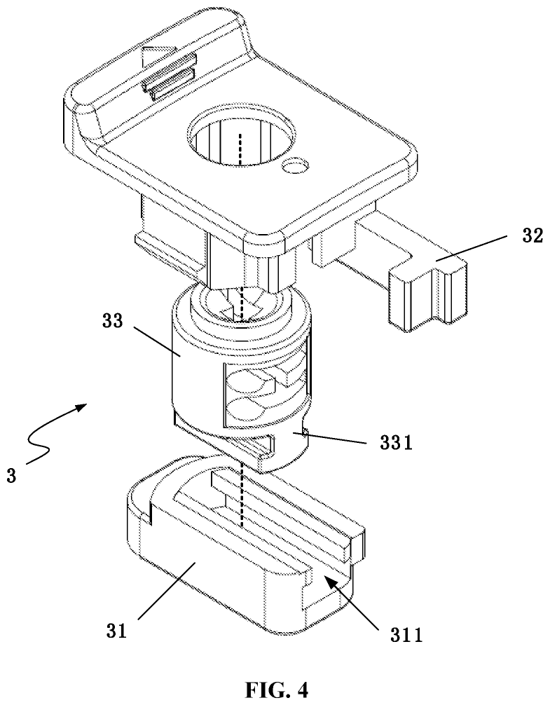

It is to be understood that the first plug portion 331 and the second plug portion 311 are configured to slide relative to each other but not to rotate relative to each other. As shown in FIG. 4, the first plug portion 331 may be a T-shaped plug block protruded from the section on one side facing toward the lock lever 31 of the lock core 33 and the second plug portion 311 may be a T-shaped plug recess dented inside the section on one side facing toward the lock core 33 of the lock lever 31. One end of the plug recess is pierced through the lock lever 31 while the other end of the plug recess is closed such that the first plug portion 331 can be plugged into the second plug portion from the open end of the plug recess. The T-shaped plug block and the T-shaped plug recess are adapted and plugged to each other to meet the purpose of the relative slide instead of the relative rotation.

Certainly, in other embodiments, the first plug portion 331 may also be a T-shaped plug recess structure and the second plug portion 311 may be a T-shaped plug block. Alternatively, the first plug portion 331 and the second plug portion 311 may also be disposed into other structures that can meet the preceding purpose of the relative slide instead of the relative rotation, which is not specifically limited herein.

It is worth noting that the closed end of the plug recess can be conducive to limit the sliding stroke of the plug block. Meanwhile, the closed end of the plug recess is disposed facing toward the combination lock mechanism 4 such that when the key lock is unlocked through the combination lock mechanism 4, the unlocking button 32 is rotated to enable the plug block to abut against the closed side of the plug recess so as to drive the lock lever 31 to move and unlock the lock bolt 2.

To facilitate exerting force, the second plug portion 311 is configured to extend in a direction parallel with a direction of a line connecting the unlocked position and the locked position when the lock core is locked. Moreover, preferably, when the lock core 33 is locked, that is, the lock bolt 2 is in the locked position, the plug block is right at the closed side of the plug recess.

In addition, in the present embodiment, the lockset further includes an ejection mechanism 5 that is configured to eject the zipper puller out of the lockset when the lock bolt 2 is in the unlocked position. As shown in FIGS. 2 to 3, the ejection mechanism 5 includes a resilient ejector block secured to the soleplate 12. When the zipper puller is pressed into the keyhole 13 and is locked with the lock bolt 2, the zipper puller is compressed downward against the resilient ejector block to make the compression spring disposed inside the resilient ejector block shrink and accumulate energy so as to enable the resilient ejector block to eject the zipper puller out of the keyhole 13 when the lock bolt is unlocked, which is convenient for the user to take the zipper puller.

Apparently, the preceding embodiments of the present disclosure are merely illustrative of the present disclosure and are not intended to limit embodiments of the present disclosure. Those of ordinary skill in the art can make various apparent modifications, adaptations, and substitutions without departing from the scope of the present disclosure. Implementations of the present disclosure cannot be and do not need to be all exhausted herein. Any modifications, equivalent substitutions, and improvements made within the spirit and principle of the present disclosure fall within the scope of the claims of the present disclosure.

What is claimed is:

1. A lockset, comprising a housing, a lock bolt disposed inside the housing and a key lock mechanism disposed inside the housing, wherein
the key lock mechanism comprises a lock lever, an unlocking button and a lock core, and the lock lever which is is slidably connected to the housing is able to rotate along with the lock core and drive the lock core to slide; and the unlocking button is hooked to the lock bolt and is able to slide along with the lock lever;
when the lock core is locked, the lock lever is configured to abut against the lock bolt to keep the lock bolt in a locked position; and
when the lock core is unlocked, the lock core is configured to drive the lock lever to rotate by a preset angle in an unlocking direction and drive the unlocking button to slide so as to make the unlocking button hooked to the lock bolt and thereby make the lock bolt move to an unlocked position.

2. The lockset according to claim 1, wherein a protrusion is disposed inside the housing, and after the lock core drives the lock lever to rotate by the preset angle in the unlocking direction, the lock lever is able to abut against the protrusion to form a sway pivot point so as to make the lock lever swayable around the sway pivot point when the lock core continues rotating in the unlocking direction.

3. The lockset according to claim 1, wherein the lock bolt is configured to use a resilient element to connect to or abut against the housing, and when the lock bolt is in the unlocked position, the resilient element is configured to generate resilient deformation and form resilient potential energy for resetting the lock bolt to the locked position.

4. The lockset according to claim 1, wherein the unlocking button is slidably connected to the housing, and the lock core is rotatably connected to the unlocking button in a manner of rotating around an axis of the lock core.

5. The lockset according to claim 4, wherein the unlocking button is configured to slide only along a direction of a line connecting the unlocked position and the locked position so as to limit a sliding direction of the lock lever.

6. The lockset according to claim 4, wherein a first plug portion is formed on one side facing toward the lock lever of the lock core, a second plug portion is formed on one side facing toward the lock core of the lock lever, and the first plug portion is able to be plugged into the second plug portion and is able to slide along the second plug portion.

7. The lockset according to claim 6, wherein the second plug portion is configured to extend in a direction parallel with a direction of a line connecting the unlocked position and the locked position when the lock core is locked.

8. The lockset according to claim 1, further comprising a combination lock mechanism, wherein the lock bolt, the key lock mechanism and the combination lock mechanism are disposed in sequence;
when the combination lock mechanism and the lock core are locked, the combination lock mechanism is configured to abut against the lock lever; and
when the combination lock mechanism is unlocked, the combination lock mechanism is configured to stop abutting the lock lever to enable the key lock mechanism to move towards the combination lock mechanism so as to make the unlocking button hooked to the lock bolt and thereby make the lock bolt move to the unlocked position.

9. A case, comprising a case body and a lockset, wherein the lockset comprises a housing, a lock bolt disposed inside the housing and a key lock mechanism disposed inside the housing, wherein
the key lock mechanism comprises a lock lever, an unlocking button and a lock core, and the lock lever which is slidably connected to the housing is able to rotate along with the lock core and drive the lock core to slide; and the unlocking button is hooked to the lock bolt and is able to slide along with the lock lever;
when the lock core is locked, the lock lever is configured to abut against the lock bolt to keep the lock bolt in a locked position; and
when the lock core is unlocked, the lock core is configured to drive the lock lever to rotate by a preset angle in an unlocking direction and drive the unlocking button to slide so as to make the unlocking button hooked to the lock bolt and thereby make the lock bolt move to an unlocked position; and
a zipper is disposed on the case body, and a zipper puller of the zipper is able to engage with the lock bolt so as to lock the zipper.

10. The case according to claim 9, further comprising an ejection mechanism, wherein the ejection mechanism is configured to eject the zipper puller out of the lockset when the lock bolt is in the unlocked position.

11. The case according to claim 9, wherein a protrusion is disposed inside the housing, and after the lock core drives the lock lever to rotate by the preset angle in the unlocking direction, the lock lever is able to abut against the protrusion to form a sway pivot point so as to make the lock lever swayable around the sway pivot point when the lock core continues rotating in the unlocking direction.

12. The case according to claim 9, wherein the lock bolt is configured to use a resilient element to connect to or abut against the housing, and when the lock bolt is in the unlocked position, the resilient element is configured to generate resilient deformation and form resilient potential energy for resetting the lock bolt to the locked position.

13. The case according to claim 9, wherein the unlocking button is slidably connected to the housing, and the lock core is rotatably connected to the unlocking button in a manner of rotating around an axis of the lock core.

14. The case according to claim 13, wherein the unlocking button is configured to slide only along a direction of a line connecting the unlocked position and the locked position so as to limit a sliding direction of the lock lever.

15. The case according to claim 13, wherein a first plug portion is formed on one side facing toward the lock lever of the lock core, a second plug portion is formed on one side facing toward the lock core of the lock lever, and the first plug portion is able to be plugged into the second plug portion and is able to slide along the second plug portion.

16. The case according to claim 15, wherein the second plug portion is configured to extend in a direction parallel with a direction of a line connecting the unlocked position and the locked position when the lock core is locked.

17. The case according to claim 9, wherein the lockset further comprises a combination lock mechanism, wherein the lock bolt, the key lock mechanism and the combination lock mechanism are disposed in sequence;
when the combination lock mechanism and the lock core are locked, the combination lock mechanism is configured to abut against the lock lever; and
when the combination lock mechanism is unlocked, the combination lock mechanism is configured to stop abutting the lock lever to enable the key lock mechanism to move towards the combination lock mechanism so as to make the unlocking button hooked to the lock bolt and thereby make the lock bolt move to the unlocked position.
